(19) United States
(12) Patent Application Publication
(10) Pub. No.: US 2019/0122253 A1
(43) Pub. Date: Apr. 25, 2019

(54) METHOD FOR ANALYZING SHOWINGS OF MEDIA CONTENT

(71) Applicant: Becton Dickinson Rowa Germany GmbH, Kelberg (DE)

(72) Inventors: Antonios Vonofakos, Frankfurt (DE); Markus Siegmann, Schwalbach (DE)

(21) Appl. No.: 15/883,324

(22) Filed: Jan. 30, 2018

(30) Foreign Application Priority Data
Oct. 20, 2017 (EP) 17197452.0

(51) Int. Cl. G06Q 30/02

(52) U.S. Cl. CPC G06Q 30/0242; G06Q 30/0272

(57) ABSTRACT

A method for analyzing the effect of showings of media content in a salesroom is provided. An overall presentation that includes multiple media contents is stored on a server computer, transmitted to a client computer, and played for a replay period on a media playback device situated in a salesroom. A reporting period is determined, and reporting information concerning the products for the reporting period is retrieved by a merchandise management system. The reporting information is compared to control information concerning the products, and the comparison results are evaluated, wherein the comparison results display the effects of the showings.

### BACKGROUND

The present disclosure relates to a method for analyzing the effect of showings of media content in a salesroom, a computer system that is configured for carrying out the method, and a computer program product that causes a microprocessor to carry out the method.

### SUMMARY

One or more disclosed embodiments provide a method for analyzing the effect of showings of media content in a salesroom that is equipped with a merchandise management system, wherein an overall presentation that includes multiple media contents is stored on a server computer. The method includes transmitting the overall presentation to a client computer of a third party and playing the overall presentation for a predefined replay period on a media playback device situated in the salesroom. The method also includes determining a reporting period as a function of the predefined replay period and specific reporting specifications. The method further includes retrieving, or receiving and storing, by the merchandise management system, for the reporting period, reporting information concerning products included in the overall presentation. The method also includes comparing the reporting information to control information concerning the products that are included in the overall presentation.

One or more disclosed embodiments provide a system for analyzing the effect of showings of media content in a salesroom. The system includes a server computer, a third party client computer and a media playback device. The system is configured to transmit an overall presentation to the third party client computer; play the overall presentation for a predefined replay period on the media playback device situated in the salesroom; determine a reporting period as a function of the predefined replay period and specific reporting specifications; retrieve, or receive and store, by a merchandise management system, for the reporting period, reporting information concerning products included in the overall presentation; and compare the reporting information to control information concerning the products that are included in the overall presentation.

One or more disclosed embodiments provide a non-transitory machine-readable storage medium comprising machine readable instructions for causing a processor to execute a method for analyzing the effect of showings of media content in a salesroom that is equipped with a merchandise management system. The method includes storing, on a server computer, an overall presentation that includes multiple media contents; transmitting the overall presentation to a client computer of a third party; playing the overall presentation for a predefined replay period on a media playback device situated in the salesroom; determining a reporting period as a function of the predefined replay period and specific reporting specifications; retrieving, or receiving and storing, by the merchandise management system, for the reporting period, reporting information concerning products included in the overall presentation; and comparing the reporting information to control information concerning the products that are included in the overall presentation.

The foregoing and other features, aspects and advantages of the disclosed embodiments will become more apparent from the following detailed description and accompanying drawings.

### BRIEF DESCRIPTION OF THE DRAWINGS

The device according to the present disclosure and the method according to the present disclosure are described in greater detail below, with reference to the appended drawings, wherein:

FIG. 1 is a flow chart of an embodiment of a method for analyzing the effect of showings of media content in a salesroom;

FIG. 2 illustrates an embodiment of a computer system configured to carry out the method of FIG. 1;

FIG. 3 illustrates an example process associated with the method of FIG. 1;

FIG. 4 illustrates an example process associated with an embodiment of a method for analyzing the effect of showings of media content in a salesroom; and

FIG. 5 illustrates an example process associated with an embodiment of a method for analyzing the effect of showings of media content in a salesroom.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions are provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the appended claims. Various aspects of the subject technology will now be disclosed according to particular but non-limiting examples. Various embodiments described in the present disclosure may be carried out in different ways and variations, and in accordance with a desired application or implementation.

The placement of media content, such as product advertising in the form of posters or the like, also for pharmacies, has been known for quite some time. In recent times, the media content is also presented via playback devices, for example television screens or the like. In such playback devices it is possible to revise the shown media content, whether still images, animations, or short commercials, with respect to a product or a service according to any desired time schedule.

There are a number of methods known in online advertising on the Internet for estimating the effectiveness of advertising as the basis for a cost-benefit analysis, for example. The effect of the advertising may be determined, for example, by analyzing how many persons “click” on a certain advertisement. The number of clicks is then an immediate indication of the effect of an advertisement.

Such direct, immediate evaluation is not possible for advertising on television or radio, for example. Instead, television or radio advertising evaluation is possible only with a high level of effort, significant time delay, and great uncertainty to determine the effect of advertising in salesrooms (e.g., dispensaries of pharmacies) for customary advertising measures such as posters and the like.

Such a method for directly evaluating the effect of showing varying media content in a salesroom is not known. The present disclosure provides a method for directly identifying an effect of showings of varying media content in a salesroom, such as a dispensary of a pharmacy. Here, a method is provided in which an overall presentation that includes multiple media contents is initially provided on a server computer, and this overall presentation is transmitted to a client computer of a third party.

This transmission may be carried out using any known data transmission method. For example, the server computer and the client computer may be connected to one another via a wireless or wired communication network. As another example, the client computer and the server computer may be connected to one another, at least temporarily, via the Internet. The technology necessary for transmitting the overall presentation is likewise known to those skilled in the art.

The overall presentation may then be played for a predefined replay period on a media playback device situated in the salesroom. This media playback device may be a television or a monitor with touchscreen functionality, for example. The media playback device may be designed to be separate from the client computer, or these two components may be designed as a single unit. The single unit may be, for example, a smart TV or the like. The predefined replay period indicates the particular time period in which the overall presentation is to be played (e.g., a week or a month).

A reporting period may then be determined as a function of the replay period and the specific reporting specifications. The specific reporting specification may be an instruction that the reporting period includes the replay period and a subsequent period to be determined. For example, if the replay period is one week and the specific reporting specification instructs to extend the replay period by one week, a reporting period of two weeks is obtained.

For the reporting period as determined above, the merchandise management system coupled to the salesroom retrieves or receives and stores reporting information. This reporting information may include the sales figures for the products included in the overall presentation. Retrieving or receiving and storing the reporting information may be carried out after the reporting period elapses. The method may retrieve or receive and store the reporting information after predefined time intervals, possibly in order to be able to immediately depict the change in the sales figures over time in response to showing an overall presentation.

The reporting information may be compared to control information concerning the products that are included in the overall presentation. The comparison results may be provided to the third party and/or to a supplier whose media content is included in the overall presentation. The comparison results may be utilized by the operator of the server computer as an incentive for a third party and/or for pricing a supplier.

Because the reporting information is compared to control information during or immediately after the defined reporting period elapses, the direct effect of showings of media content in a salesroom may be determined. To this end, it may be necessary to access, at least after the reporting period, the merchandise management system that is coupled to the salesroom. Thus, a merchandise management system may be provided that monitors the sales in the salesroom in which the media playback device is situated.

The disclosed method may quickly determine whether the media content included in the overall presentation has effects on the sale of products in the salesroom, in particular for the case that within a predetermined replay period an overall presentation is played with a variety of media content. Thus, media content concerning a plurality of products may be played within a predefined time period, although at the same time it is possible to examine the effect of showing multiple media contents.

The exact manner in which the overall presentation including the multiple media contents is compiled (e.g., how much and which media content is included) is not relevant for the present disclosure. To allow a third party (e.g., a pharmacist) to adapt to local specifications or personal preferences, but at the same time to minimize the time required for the adaptation, in one or more embodiments it is provided that the overall presentation may be prepared such that at least one draft presentation including multiple media contents is provided on the server computer, and a third party selects the particular media content of a draft presentation that is to be included in the overall presentation. If multiple draft presentations are provided, a selection of one of the multiple draft presentations by the third party may also be required. The selection may be made, for example, by a third party selecting the particular media content of a draft presentation that is not to be included in the overall presentation, wherein it may be provided that it is specified on the server computer that the overall presentation must or may include at least and/or at most x media contents. In addition, it may be specified that certain media content may be accepted only together with other media content (e.g., some other “coupled” media content is likewise chosen by selecting a certain media content). In one or more embodiments, it may be provided that the third party actively searches the media content, wherein the above-mentioned requirements (e.g., number, coupling of multiple media contents) may apply.

In one or more embodiments in which a third party is given greater latitude for affecting the overall presentation, it may be provided that the overall presentation is prepared such that a third party receives presentation specifications for a desired overall presentation and stores them on the server computer, a supplier of products receives media contents concerning products and stores them on the server computer, media content stored on the server computer is compiled by at least one supplier into an overall presentation that includes multiple media contents, taking into account the presentation specifications of the third party, and this overall presentation is transmitted to a client computer of the third party. Here also, the above-mentioned requirements for compiling an overall presentation may be specified.

Presentation specifications may be compiled by a third party (e.g., an operator of the salesroom) and transmitted to or received by the server computer and stored there. With the presentation specifications, the third party may describe media content/products that should preferably be compiled to form the overall presentation.

The presentation specifications may concern, for example, various product groups that are to be offered in the salesroom. In pharmacies, the presentation specifications may stipulate, for example, that the overall presentation includes media content concerning cold and flu remedies. As another example, it may be stipulated that the overall presentation includes only media content for products that have been on the market for six months or less. The exact form of the presentation specifications may depend on the type of products sold in the salesroom, and may be refined as desired as a function of the needs of the third party and the type of products offered.

Within the scope of the present disclosure, the term “products” is intended to include products per se as well as services (e.g., the media content may also show the services of a nearby service provider).

The exact manner in which the overall presentation is compiled, based on the presentation specifications provided by a third party and stored on the server computer, may be carried out in numerous ways, depending on the software used for this purpose. The compilation of an overall presentation based on specified criteria is known.

In one or more embodiments, in which the options of a third party to affect the overall presentation are more limited, but in which compiling the overall presentation may be carried out more quickly, it is provided that the overall presentation is prepared in that at least one draft presentation including multiple media contents is provided on the server computer, presentation specifications for a desired overall presentation are received by a third party and stored on the server computer, a draft presentation is selected, taking into account the presentation specifications, and the particular media content of a draft presentation that is to be included in the overall presentation are selected, taking into account the presentation specifications. Thus, based on the presentation specifications, the particular draft presentation that best fits the presentation specifications is selected and if only one is present, that one is automatically selected. Subsequently, the particular media content that best fits the presentation specifications is compiled to form the overall presentation. Here, the option for the third party to participate is still relatively far-reaching due to the specification of draft presentations, but the operator of the server computer or the supplier of the media content may also influence the overall presentation. Thus, for example, a draft presentation may include only media content concerning products of one supplier.

The overall presentation may be provided, taking into account the presentation specifications of a third party. Of course, the media content is always provided that contains information about which product and from which manufacturer it relates to in order to file the media content, internally sorted, in a database on the server computer. In one or more embodiments, it is provided that the media content from a supplier is provided together with a media tag. This media tag may, for example, describe supplier incentives that accrue when a third party accepts the media content into the overall presentation desired by the third party. Thus, for example, the media tag of media content may indicate that for accepting the media content in question into the overall presentation, the third party receives remuneration of X euros per played hour of the overall presentation. This may be meaningful when a supplier would like to launch a new product on the market. A third party may then prefer appropriately tagged media content by indicating in the presentation specifications that media content associated with a supplier incentive is to be preferentially accepted in the overall presentation.

It is also provided that an overall presentation may be played on the media playback device for a predefined replay period. As noted above, this replay period may be one week, for example, where the same overall presentation is played in a loop, optionally interrupted by additional information, during the business hours of the salesroom. However, the predefined replay period may also be much shorter. For example, it may be provided that a replay period is only one-half a sales day and that two overall presentations are played on a sales day. This may be meaningful when it has been determined based on experience that, for example, in the morning a different clientele visits the salesroom than is the case in the afternoon.

Even when the predefined replay periods on a sales day are selected so that multiple overall presentations can be shown, this specification is static. In order for the third party to be able to respond dynamically to certain circumstances, in one or more embodiments of the method it is provided that, as soon as new presentation specifications are received from the third party, media content that is stored on the server computer is compiled, taking into account the media specifications of the third party and/or the media tags, to form a new overall presentation that is provided to the third party for replay. In one or more embodiments, the new overall presentation may be prepared based on the presentation specifications of a provided draft presentation. Thus, a third party may respond quickly to a sudden change in the weather, for example, and accordingly adapt the overall presentation.

In one or more embodiments, it is provided that the presentation specifications of the third party are determined taking into account customers who are present in the salesroom. To accomplish this, for example, it may be provided to scan the MAC addresses of customers' mobile telephones, and on the basis of purchasing behaviors that are known for these MAC addresses (e.g., customers), to develop new presentation specifications which are then immediately transmitted to the server computer in order to create a new overall presentation. It is thus possible to respond immediately to customers who are present in the salesroom. Thus, when utilizing the MAC addresses of the customers' mobile telephones, it may be necessary to store the purchasing behaviors associated with the customer or MAC addresses for an extended period of time in order to obtain a reliable database.

The overall presentation for a predefined period, optionally interspersed with additional information, may be repeated in a loop. To allow a customer to obtain more information about media content that has just played, or about the product shown in the media content, in one or more embodiments it is provided that media content together with additional content is received and stored, the additional content being included when the overall presentation is compiled, and that additional content is played on the media playback device when the media playback device is activated. The media playback device may be activated, for example, by a customer pressing on the media playback device when it has touchscreen functionality. An actuator may be assigned to the media playback device, which activates the replay of the additional content when the actuator is actuated.

As described above, the overall presentation may be repeated in a loop within the predefined replay period. Depending on the length of the media content and the average amount of time that a customer spends in the salesroom, it is possible that a customer will see the playing of only one media content during the time spent in the salesroom. Alternatively, it is possible that a customer may see the overall presentation several times. It may be desire to avoid both scenarios.

In one or more embodiments, it is therefore provided that the compilation of the overall presentation is adapted to an average length of stay of a customer in the salesroom. If it is determined, for example, that the average length of stay of a customer in a salesroom is five minutes, it may be meaningful to compile an overall presentation made up of 10 media contents, each lasting 30 seconds. It is then ensured that the “average” customer sees, or has the chance to see, all media contents of the overall presentation.

The present disclosure further relates to a computer system having a server computer, a client computer, and a media playback device, wherein the specified components as described above communicate with one another, or may be designed to do so. Furthermore, the components of the computer system are configured for carrying out the disclosed methods.

In addition, the present disclosure encompasses a computer program product containing program instructions that cause a microprocessor to carry out and/or control the method according to the disclosure.

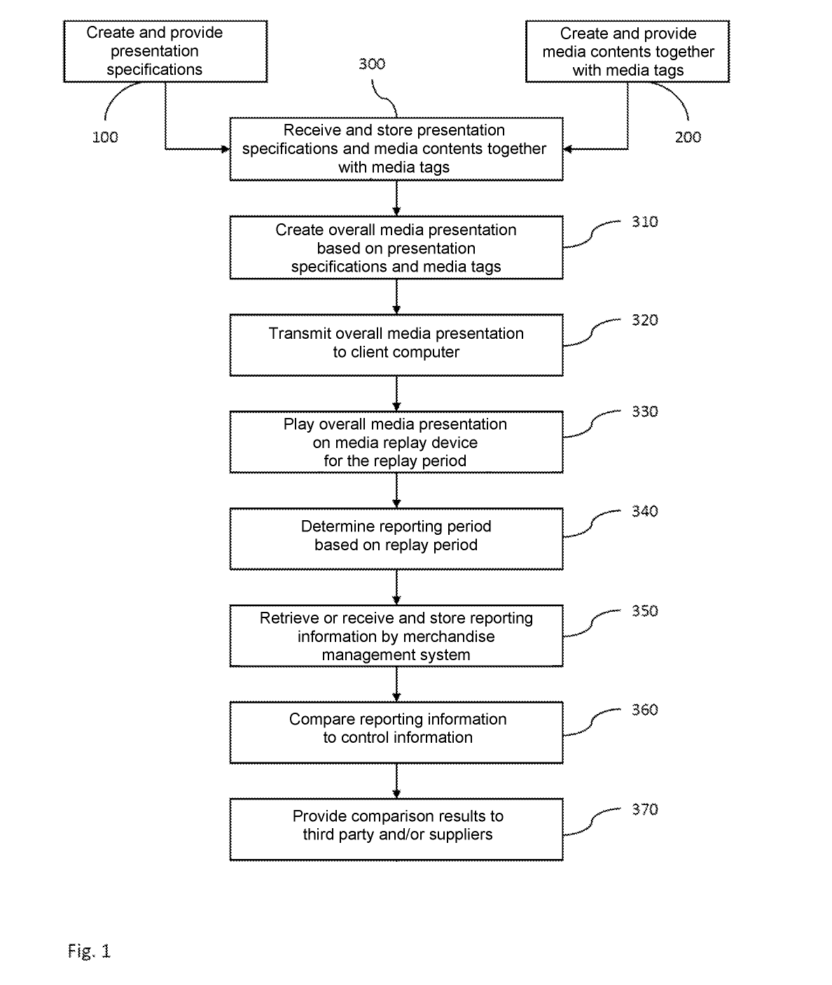

With reference to FIGS. 1-3, in one or more embodiments of the method, presentation specifications PV1-PVx are provided on a computer 20, 21 by a third party 10, 11 in step 100, and are received and stored by a server computer 90, which is part of a computer system. The presentation specifications PV1-PVx indicate criteria for the particular media content a third party 10, 11 would like to have compiled in the overall presentation GP desired by the third party 10, 11.

Similarly in step 200, a supplier 30, 31 provides media contents MI1-MIx together with appropriate media tags MT1-MTx on a computer 40, 41, and these are received and stored by the server computer 90.

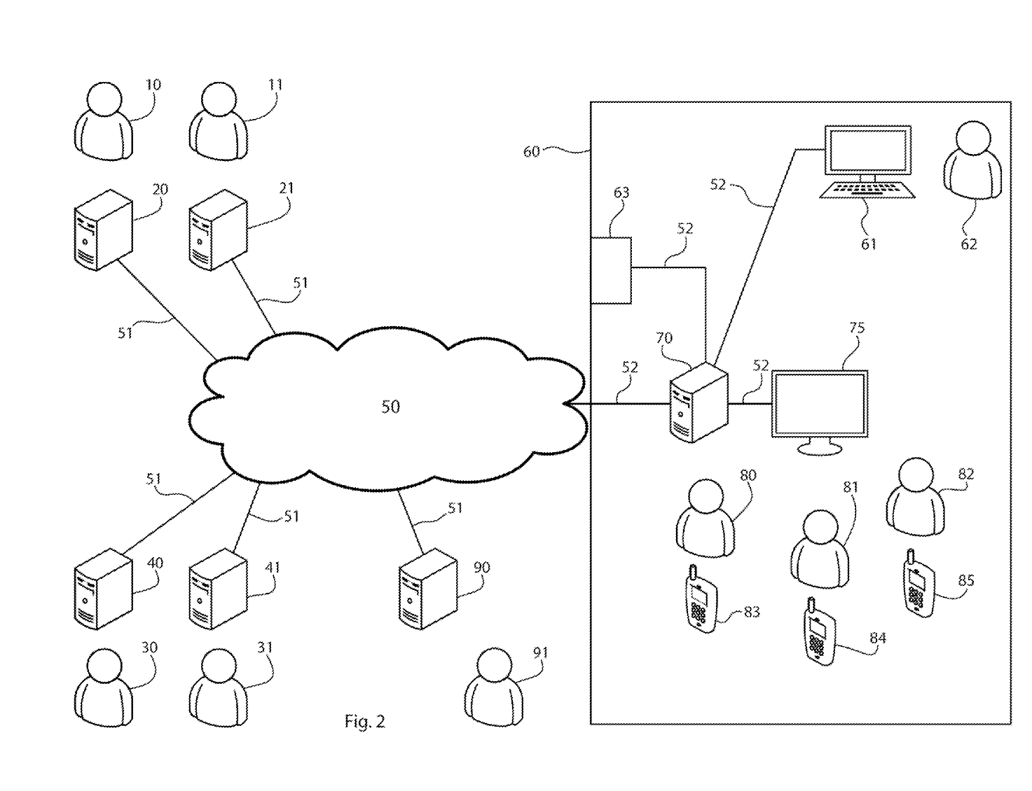

As shown in FIG. 2, two third parties 10, 11 and two suppliers 30, 31 are illustrated for purposes of explanation. The method as such is intended to determine the effects of an overall presentation that is shown by a third party in a salesroom where the overall presentation may include media content from any number of suppliers. However, the method itself may be carried out for a plurality of third parties, for which reason two third parties 10, 11 are illustrated by way of example.

In one or more embodiments of the method, the third party 10, 11 is an operator of a pharmacy, and the suppliers 30, 31 are suppliers of over-the-counter products (e.g., baby food, sun protection products, or mild pain relievers) that are available for sale in the pharmacy. The presentation specifications PV1-PVx that are specified by the third party 10, 11 may thus state, for example, that the overall presentation desired by the third party 10, 11 is to include only sun protection products and baby food products, since according to the experience of the third party 10, 11 these products are in particularly high demand in the pharmacy.

The presentation specifications PV1-PVx and the media contents MI1-MIx, together with media tags MT1-MTx, are provided via communication links 51 of a communication network 50 to the server computer 90 of a service provider 91 that compiles the above-mentioned information into an overall presentation GP, and are received and stored by the server computer 90. The communication network 50 may be a wireless or wired network, and the communication links 51 may correspondingly be wireless or wired connections. For example, the computers 20, 21 of a third party 10, 11 or the computers 40, 41 of the suppliers 30, 31 may be connected to the server computer 90 via the World Wide Web (WWW), also referred to as the Internet. As another example, one portion of the communication links 51 may be wireless and another portion may be wired. The exact manner in which the connection between the computers 20, 21 of a third party 10, 11, the computers 40, 41 of the suppliers 30, 31, and the server computer 90 of the service provider 91 takes place is not relevant for the present disclosure. Any known communication network and system may be used, while the security measures that are customary for a third party, the suppliers, and the service provider for the particular network or system may routinely be followed.

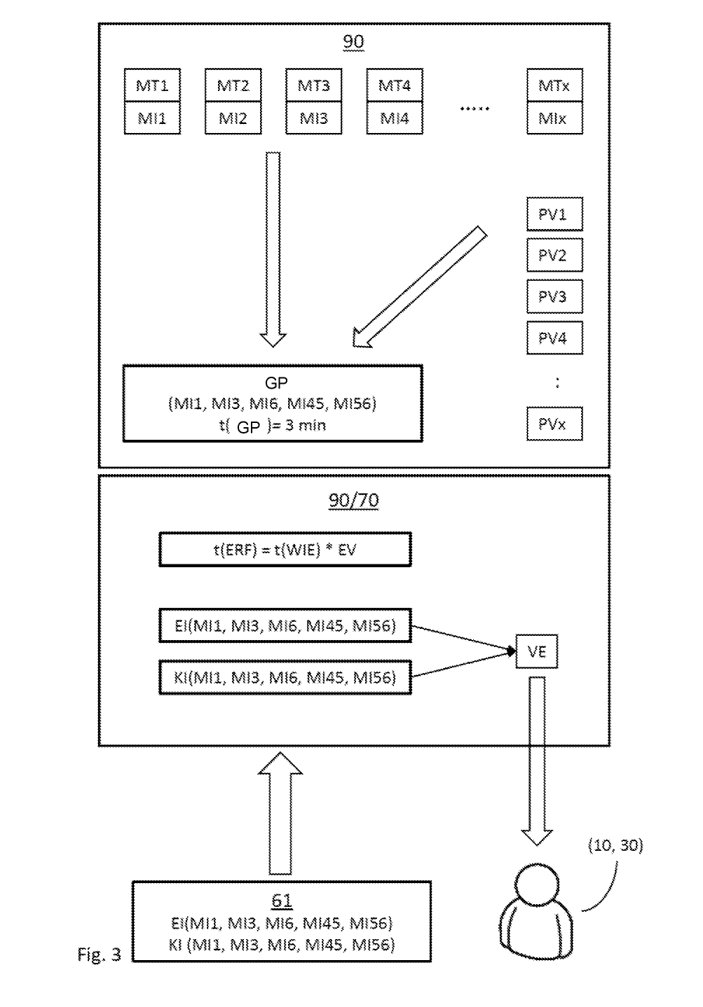

After the presentation specifications PV1-PVx and media contents MI1-MIx together with media tags MT1-MTx have been received and stored by the server computer 90 in a step 300, an overall presentation GP is compiled, based on the presentation specifications PV1-PVx and media tags MT1-MTx, in step 310, as illustrated in greater detail in FIG. 3.

In the example shown in FIG. 3, presentation specifications PV1-PVx have been provided by a third party, on the basis of which an overall presentation GP including the media contents MI1, MI3, MI6, MI45, MI56 stored on the server computer 90 has been compiled, using the media tags MT1-MTx. The aforementioned media contents MI1, MI3, MI6, MI45, MI56 may involve short videos, each presenting one product. The total length of the overall presentation GP is determined primarily by the length of the media contents MI1, MI3, MI6, MI45, MI56 included, which may be separated from one another by brief breaks. For example, if the aforementioned media contents MI1, MI3, MI6, MI45, MI56 are each 30 seconds long and are separated by a break of 6 seconds, the total length t(GP) of the overall presentation GP is 3 minutes, where the last media content MI56 is followed by a break. The exact format of the overall presentation GP is defined in each case by the input presentation specifications, and may differ from the above description if desired.

The previously compiled overall presentation GP is transmitted to a client computer 70 of the third party via communication links and the communication network 50 in step 320. The client computer 70 of the third party is connected to the communication network 50 via a communication link 52, and is part of the computer system according to the disclosure. The communication link 52 between the client computer 70 and the communication network 50 may also be wireless or wired.

As shown in FIG. 2, the client computer 70 of the third party is situated in a salesroom 60, and is connected to a media playback device 75 via a further communication link 52. The media playback device 75 may be part of a dedicated computer, or it may also be the customary display device of the above-mentioned client computer 70 to which the overall presentation GP has been transmitted. The example described here involves the salesroom 60 at a dispensary of a pharmacy.

The overall presentation GP is played on the media playback device 75, situated in the salesroom 60, for a predefined replay period t(WIE) in step 330. The replay period t(WIE) is specified by the third party 10, 11, and may be one week, for example. As another example, the replay period t(WIE) may be configured so that on a given sales day two overall presentations GP are played, for example one in the morning and the other in the afternoon. It is also possible for the replay period t(WIE) to correspond to the total length of the overall presentation GP, for example when the total length of the overall presentation GP is long, and after running for an extended period a different media content MI1, MI3, MI6, MI45, MI56 is to be played.

A reporting period t(ERF) is determined, based on the replay period t(WIE) and specific reporting specifications EV, in step 340. This reporting period t(ERF) indicates within which time period the effects of showings of the media contents MI1, MI3, MI6, MI45, MI56 of the overall presentation GP are to be analyzed. For example, it is possible to carry out the analysis after the end of a one-week replay period t(WIE). As another example, it is possible to begin the analysis at the same time that the playing of the overall presentation GP starts in the salesroom 60 of the third party 10, 11, and to continue the analysis for 10 days. The exact reporting specifications EV that are defined depend on the design of the overall presentation GP, the replay period t(WIE), and the specific specifications of the third party 10, 11, which also depend on the type of salesroom 60. Thus, the exact form of the reporting period t(ERF) based on the reporting specifications EV may be any desired period.

In step 350, a merchandise management system 61 retrieves (or receives) and stores, for the reporting period t(ERF), reporting information EI about the products included in the overall presentation GP. For this purpose, the merchandise management system 61 is at least temporarily connected to the client computer 70 via a communication link 52, as illustrated in FIG. 2. In one or more embodiments, the merchandise management system 61 may be at least temporarily connected to the server computer 90 of the service provider 91 via the communication network 50. The merchandise management system 61 is likewise part of the computer system according to the disclosure.

The merchandise management system 61 may, for example, be coupled to a picking device (not illustrated in the figures) in which at least some of the products included in the overall presentation GP may be stored and taken out on instruction by a pharmacist 62 operating the merchandise management system 61.

The reporting information EI received from the merchandise management system 61 is compared to control information KI in step 360. The control information KI indicates the sales figures of the products, included in the overall presentation GP, for a certain time period. It may be desired that this time period not be influenced by the playing of a similar overall presentation GP that includes several of the products in the overall presentation GP under consideration at the moment. However, it may not be detrimental if a small number of the products in the overall presentation GP under consideration at the moment have also been shown in a control period. In such a case, however, only a limited analysis of the effect of showing the media content MI1, MI3, MI6, MI45, MI56 is then possible for these products, such as evaluating the extent to which repeated playing of the media content MI1, MI3, MI6, MI45, MI56 has an effect on the purchasing behavior of customers, for example.

In step 370, the results VE determined in the comparison are provided to the third party 10, 11 and/or suppliers 30, 31 of the products that were included in the overall presentation GP.

As is apparent in FIG. 2, some of the above-mentioned steps must necessarily be carried out on the server computer 90 of the service provider 91, for example the compiling of the overall presentation GP. Subsequent method steps, such as determining the reporting period t(ERF) and/or retrieving or receiving and storing the reporting information EI, may be carried out by the client computer 70 and/or the server computer 90. Thus, the division of the aforementioned method steps may be carried out based on considerations of practicability.

Based on the comparison results, it is possible for the third party 10, 11 and/or suppliers 30, 31 to determine to what extent the showing of the media content MI1, MI3, MI6, MI45, MI56 on the media playback device 75 within the salesroom 60 of a third party 10, 11 promotes sales of the products shown in an overall presentation GP.

For example, a comparison could show that a product associated with a media content MI1 was sold x times for a control period t(KON), but sales were 7% higher in the reporting period t(ERF). For a different media content MI3, MI6, MI45, MI56 involving a different product, it may be determined, for example, that the sales were not positively influenced for a time period in question. This may indicate, for example, that the media content MI3, MI6, MI45, MI56 is not well received by a customer.

In one or more embodiments, the overall presentation GP is played on the media playback device 75 for a predetermined replay period t(WIE). Here, the method would be static and not influenced by dynamic factors.

In one or more embodiments, the presentation specifications PV1-PVx may be dependent on external influences. Thus, the method may replace an overall presentation GP playing at the moment with a new overall presentation GP when the third party 10, 11 becomes aware that, for example, there will be a significant, long-lasting change in the weather conditions.

In one or more embodiments, the overall presentation GP playing at the moment in a salesroom 60 may be dependent on customers 80, 81, 82 who are present at the moment in the salesroom (see FIG. 2). For example, the MAC addresses of the mobile devices 83, 84, 85 carried by the customers 80, 81, 82 may be read out via a scanning device 63 upon entry into the salesroom 60.

The merchandise management system may determine whether data are present for a customer 80, 81, 82 (e.g., having a mobile device with a certain MAC address) that allow conclusions to be drawn concerning the purchasing preferences of the customer 80, 81, 82. If this is determined, for example, for five customers 80, 81, 82 that are present in the salesroom at the same time, it may be worthwhile to create new presentation specifications PV, based on the purchasing preferences of these customers 80, 81, 82, and relay them to the server computer 90 for immediate compilation and provision of a new overall presentation GP. Thus, while particular customer groups are present, media content MI1, MI3, MI6, MI45, MI56 concerning those products that are preferentially purchased by the customers 80, 81, 82 who are present in the salesroom 60 may be played.

In one or more embodiments, it may be provided to adapt the total length t(GP) of the overall presentation GP to the average length of stay of a customer 80, 81, 82 in the salesroom 60, so that a customer 80, 81, 82 on average has the chance to see all media contents MI1, MI3, MI6, MI45, MI56 of the overall presentation GP during the stay in the salesroom 60. Here, the overall presentation GP has been compiled based on the presentation specifications PV1-PVx of a third party 10, 11.

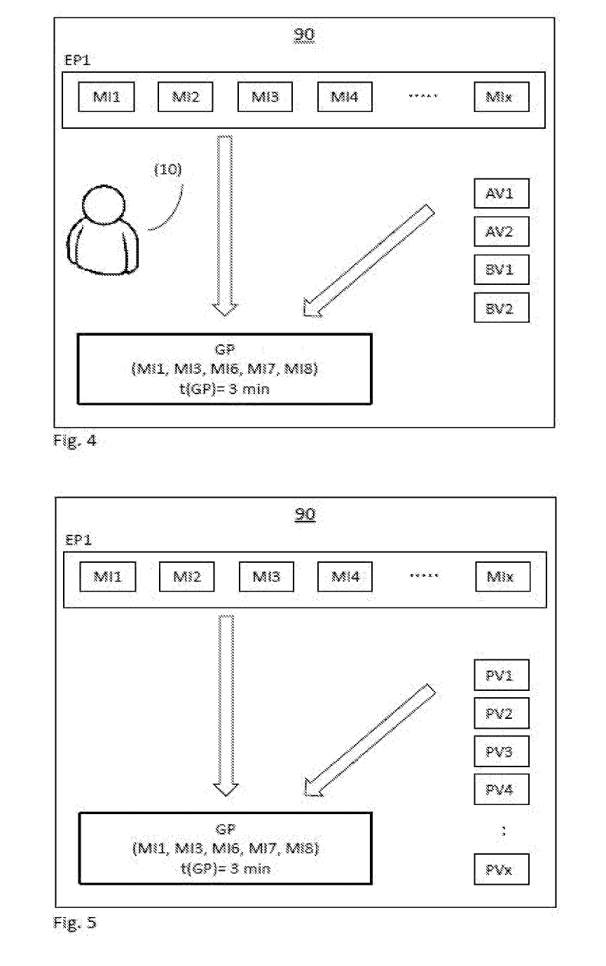

As described above and illustrated in FIG. 4, the overall presentation GP may be prepared by providing one or more draft presentations EP1 on the server computer 90. These include in each case a plurality of media contents MI1-MIx. The third party 10 may compile the overall presentation GP, for example, by selecting from these x media contents MI1-MIx, the particular media content MI1-MIx that is not to be included in the overall presentation GP. Alternatively, the particular media content MI1-MIx that is to be included in the overall presentation GP may be selected. In compiling the overall presentation GP, it may be provided that supplier specifications AV1, AV2 and/or operator specifications BV1, BV2 must be followed. A supplier specification AV1, AV2 may be, for example, that a media content MIx may be included only together with media content MI2, or that when MIx is accepted in the overall presentation, accepting MI2 is not possible. An operator specification BV1, BV2 may be that the overall presentation GP includes at least x media contents MI1, MI3, MI6, MI7, MI8 and/or is at least 3 minutes long, for example. After the overall presentation GP is compiled, the method sequence may correspond to method sequences described above.

In one or more embodiments as illustrated in FIG. 5, the two variants mentioned above for compiling the overall presentation GP may also be combined, in particular in that the overall presentation GP is selected and compiled based on presentation specifications PV1-PVx of a third party 10, 11. After the overall presentation GP is compiled, once again the method sequence may correspond to method sequences described above.

The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

The word “exemplary” or the term “for example” is used herein to mean “serving as an example or illustration.” Any aspect or design described herein as “exemplary” or “for example” is not necessarily to be construed as preferred or advantageous over other aspects or designs. In one aspect, various alternative configurations and operations described herein may be considered to be at least equivalent.

As used herein, the phrase “at least one of” preceding a series of items, with the term “or” to separate any of the items, modifies the list as a whole, rather than each item of the list. The phrase “at least one of” does not require selection of at least one item; rather, the phrase allows a meaning that includes at least one of any one of the items, and/or at least one of any combination of the items, and/or at least one of each of the items. By way of example, the phrase “at least one of A, B, or C” may refer to: only A, only B, or only C; or any combination of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain.

It is understood that the specific order or hierarchy of steps, operations or processes disclosed is an illustration of exemplary approaches. Based upon design preferences, it is understood that the specific order or hierarchy of steps, operations or processes may be rearranged. Some of the steps, operations or processes may be performed simultaneously. Some or all of the steps, operations, or processes may be performed automatically, without the intervention of a user. The accompanying method claims, if any, present elements of the various steps, operations or processes in a sample order, and are not meant to be limited to the specific order or hierarchy presented.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.” Furthermore, to the extent that the term “include,” “have,” or the like is used, such term is intended to be inclusive in a manner similar to the term “comprise” as “comprise” is interpreted when employed as a transitional word in a claim.

The Title, Background, Summary, Brief Description of the Drawings and Abstract of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples and the various features are grouped together in various embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the Detailed Description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirement of 35 U.S.C. § 101, 102, or 103, nor should they be interpreted in such a way.

1. A method for analyzing an effect of showings of media content in a salesroom that is equipped with a merchandise management system, wherein an overall presentation that includes multiple media contents is stored on a server computer, the method comprising:
transmitting the overall presentation to a client computer of a third party;
playing the overall presentation for a predefined replay period on a media playback device situated in the salesroom;
determining a reporting period as a function of the predefined replay period and specific reporting specifications;
retrieving, or receiving and storing, by the merchandise management system, for the reporting period, reporting information concerning products included in the overall presentation; and
comparing the reporting information to control information concerning the products that are included in the overall presentation.

2. The method of claim 1, wherein preparing the overall presentation comprises:
providing, on the server computer, at least one draft presentation that includes multiple media contents; and
selecting, by a third party, one or more of the multiple media contents of the draft presentation that are to be included in the overall presentation.

3. The method of claim 1, wherein preparing the overall presentation comprises:
receiving, by a third party, presentation specifications for a desired overall presentation;
storing the presentation specifications on the server computer; and
compiling, by a supplier, media content stored on the server computer to form the overall presentation that includes the multiple media contents, taking into account the presentation specifications of the third party.

4. The method of claim 3, wherein the media content is provided with media tags by the supplier, and wherein the media content is compiled to form an overall presentation, taking into account the presentation specifications and the media tags.

5. The method of claim 4, further comprising:
receiving new presentation specifications from the third party; and
compiling media contents from at least one supplier that are stored on the server computer, taking into account at least one of the presentation specifications of the third party and the media tags, to form a new overall presentation that includes multiple media contents.

6. The method of claim 3, further comprising:
receiving new presentation specifications from the third party; and
selecting particular media content of a draft presentation that is to be included in a new overall presentation, taking into account the presentation specifications.

7. The method of claim 3, wherein the presentation specifications are determined by taking into account customers who are present in the salesroom.

8. The method of claim 3, wherein the presentation specifications are determined taking into account at least one of times of the year, times of the day and days of the week.

9. The method of claim 3, further comprising:
receiving and storing additional content together with the media content, wherein the additional content is included when the overall media presentation is compiled; and
playing the additional content on the media playback device when the media playback device is activated.

10. The method of claim 3, wherein the compilation of the overall presentation is adapted to an average length of stay of a customer in the salesroom.

11. The method of claim 1, wherein preparing the overall presentation comprises:
providing, on the server computer, at least one draft presentation that includes multiple media contents;
receiving, by the third party, presentation specifications for a desired overall presentation;
storing the presentation specifications on the server computer;
selecting a draft presentation, taking into account the presentation specifications; and
selecting one or more of the multiple media contents of the draft presentation that are to be included in the overall presentation, taking into account the presentation specifications.

12. The method of claim 11, wherein the media content is provided with media tags by a supplier, and wherein the media content is compiled to form the overall presentation, taking into account the presentation specifications and the media tags.

13. The method of claim 12, further comprising:
receiving new presentation specifications from the third party; and
compiling media contents from at least one supplier that are stored on the server computer, taking into account at least one of the presentation specifications of the third party and the media tags, to form a new overall presentation that includes multiple media contents.

14. The method of claim 11, further comprising:
receiving new presentation specifications from the third party; and
selecting particular media content of a draft presentation that is to be included in a new overall presentation, taking into account the presentation specifications.

15. The method of claim 11, wherein the presentation specifications are determined by taking into account customers who are present in the salesroom.

16. The method of claim 11, wherein the presentation specifications are determined taking into account at least one of times of the year, times of the day and days of the week.

17. The method of claim 11, further comprising:
receiving and storing additional content together with the media content, wherein the additional content is included when the overall media presentation is compiled; and
playing the additional content on the media playback device when the media playback device is activated.

18. The method of claim 17, wherein the compilation of the overall presentation is adapted to an average length of stay of a customer in the salesroom.

19. A system for analyzing an effect of showings of media content in a salesroom, the system comprising:
a server computer;
a third party client computer; and
a media playback device,
wherein the system is configured to:
transmit an overall presentation to the third party client computer;
play the overall presentation for a predefined replay period on the media playback device situated in the salesroom;
determine a reporting period as a function of the predefined replay period and specific reporting specifications;
retrieve, or receive and store, by a merchandise management system, for the reporting period, reporting information concerning products included in the overall presentation; and
compare the reporting information to control information concerning the products that are included in the overall presentation.

20. A non-transitory machine-readable storage medium comprising machine readable instructions for causing a processor to execute a method for analyzing an effect of showings of media content in a salesroom that is equipped with a merchandise management system, the method comprising:
storing, on a server computer, an overall presentation that includes multiple media contents;
transmitting the overall presentation to a client computer of a third party;
playing the overall presentation for a predefined replay period on a media playback device situated in the salesroom;
determining a reporting period as a function of the predefined replay period and specific reporting specifications;
retrieving, or receiving and storing, by the merchandise management system, for the reporting period, reporting information concerning products included in the overall presentation; and
comparing the reporting information to control information concerning the products that are included in the overall presentation.
